(19) United States
(12) Patent Application Publication
(10) Pub. No.: US 2024/0359458 A1
(43) Pub. Date: Oct. 31, 2024

(54) INKJET RECORDING APPARATUS

(71) Applicant: KYOCERA Document Solutions Inc., Osaka (JP)

(72) Inventor: Aiichiro OTANA, Osaka (JP)

(73) Assignee: KYOCERA Document Solutions Inc., Osaka (JP)

(21) Appl. No.: 18/640,594

(22) Filed: Apr. 19, 2024

(30) Foreign Application Priority Data
Apr. 26, 2023 (JP) 2023-072032

(51) Int. Cl. B41J 2/045; B41J 2/165; B41J 2/21; B41J 11/00; B41J 13/08

(52) U.S. Cl. CPC B41J 2/04526; B41J 2/04586; B41J 2/16526; B41J 2/2103; B41J 11/0095; B41J 13/08

(57) ABSTRACT

The inkjet recording apparatus includes a recording head, a recording medium conveyance part, an abnormality detection part, a retraction mechanism, and a controller. The retraction mechanism makes the recording head moved between a recording position and a retraction position. The controller being enabled to execute a flashing operation under a non-image recording situation, on condition that an abnormality of the recording medium has been detected by the abnormality detection part, the controller halts the flashing operation set for a forward proximity of the abnormality-detected recording medium, and moreover instructs the retraction mechanism to move the recording head to the retraction position so as to allow the abnormality-detected recording medium to pass through under the recording head.

### INCORPORATION BY REFERENCE

This application is based on and claims the benefit of priority from Japanese Patent Application No. 2023-072032 filed on Apr. 26, 2023, the contents of which are hereby incorporated by reference.

### BACKGROUND

The present disclosure relates to an inkjet recording apparatus.

As for inkjet recording apparatuses, in order to reduce and prevent nozzle clogging due to ink drying, it has been a practice to regularly perform flashing (idle ejection) which involves ejecting ink from nozzles. The flashing is carried out by ink being ejected in a linear form extending along a sheet widthwise direction perpendicular to a sheet conveyance direction under a non-image recording situation which involves no ink ejection onto a paper sheet or other recording medium.

### SUMMARY

An inkjet recording apparatus according to one aspect of the present disclosure includes a recording head, a recording medium conveyance part, an abnormality detection part, a retraction mechanism, and a controller. The recording head ejects ink onto the recording medium to record an image thereon. The recording medium conveyance part is placed in opposition to the recording head to convey the recording medium. The abnormality detection part detects an abnormality of the recording medium conveyed toward the recording head. The retraction mechanism makes the recording head moved between a recording position for execution of recording and a retraction position. The controller controls operations of the recording head, the recording medium conveyance part, and the retraction mechanism. The controller being enabled to execute a flashing operation, which involves ejection of ink from the recording head, under a non-image recording situation in which no ink is ejected onto the recording medium, on condition that an abnormality of the recording medium has been detected by the abnormality detection part, the controller halts the flashing operation set for a forward proximity of the abnormality-detected recording medium, and moreover instructs the retraction mechanism to move the recording head to the retraction position so as to allow the abnormality-detected recording medium to pass through a position of the recording head.

### BRIEF DESCRIPTION OF THE DRAWINGS

FIG. 1 is a schematic cross-sectional front view of an inkjet recording apparatus according to an embodiment of this disclosure;

FIG. 2 is a top view of around a recording part in the inkjet recording apparatus of FIG. 1;

FIG. 3 is a schematic block diagram of the inkjet recording apparatus of FIG. 1;

FIG. 4 is an explanatory view schematically showing a configuration extending from a sheet feed part to a second belt conveyance part along a sheet conveyance path in FIG. 1;

FIG. 5 is a plan view of a first conveyor belt of a first belt conveyance part of FIG. 4;

FIG. 6 is a schematic partial cross-sectional front view of around the recording part of FIG. 4; and

FIG. 7 is a flowchart showing an example of execution process of a flashing operation in the inkjet recording apparatus of FIG. 1.

### DETAILED DESCRIPTION

Hereinafter, an embodiment of the present disclosure will be described with reference to the accompanying drawings. It is to be noted that the present disclosure is not limited to the following contents.

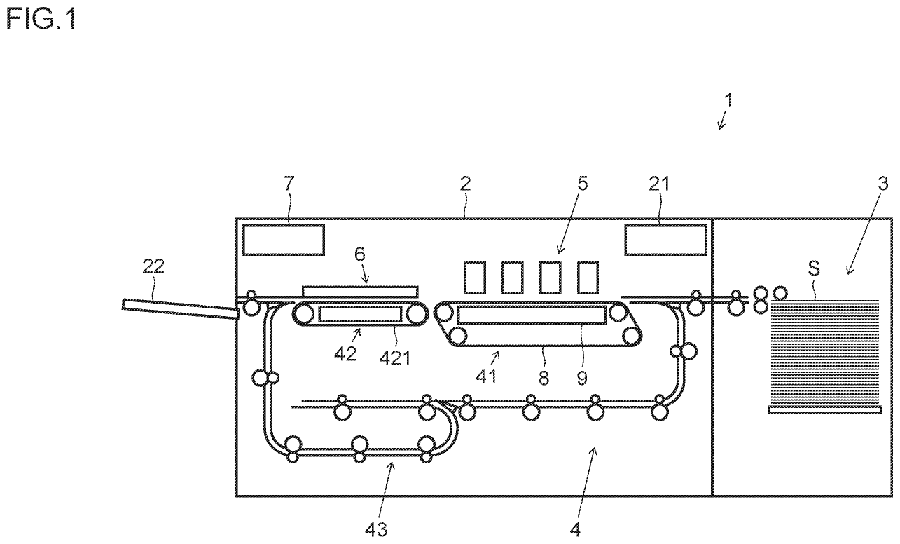

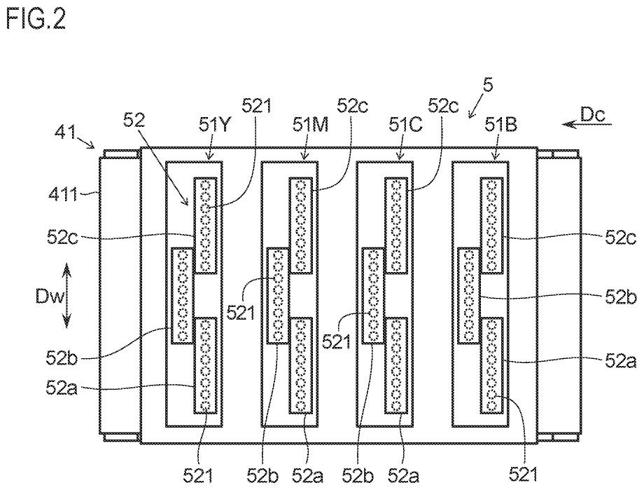

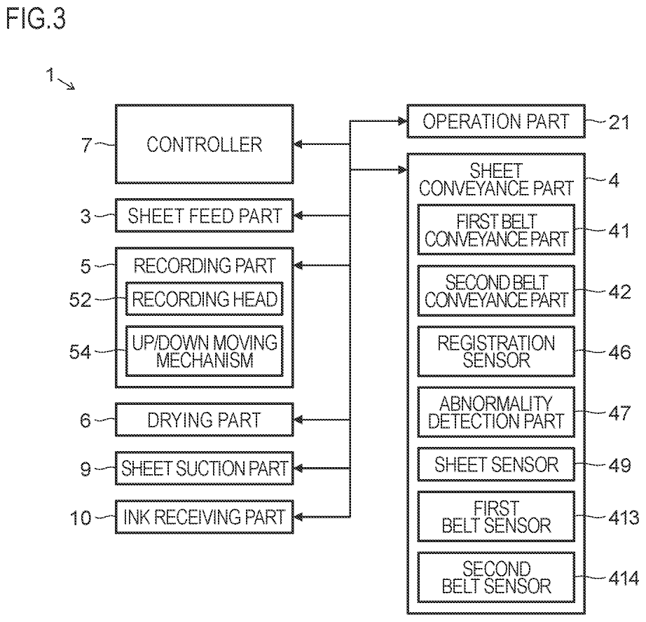

FIG. 1 is a schematic cross-sectional front view of an inkjet recording apparatus 1 according to an embodiment. FIG. 2 is a top view of around a recording part 5 in the inkjet recording apparatus 1 of FIG. 1. FIG. 3 is a schematic block diagram of the inkjet recording apparatus 1 of FIG. 1. The inkjet recording apparatus 1 is a printer of inkjet recording type, as an example. As shown in FIGS. 1, 2 and 3, the inkjet recording apparatus 1 includes an apparatus housing 2, a sheet feed part 3, a sheet conveyance part 4, a recording part 5, a drying part 6, and a controller 7.

The apparatus housing 2 includes an operation part (input part) 21. The operation part 21 is placed, for example, at a frontal upper portion of the apparatus housing 2 to accept, directly from a user himself/herself, inputs such as settings of recording conditions for type of paper sheets (recording medium) to be used for recording, scale-up and -down, and a need or not for double-sided recording, as well as execution instructions and the like. The type of sheets may include, for example, settings of size, thickness, and material (paper, OHP sheet, etc.). It is also allowable that such inputs as image data, recording conditions and execution instructions are accepted from an external computer via a communication part (not shown) of the apparatus housing 2 to which a network line or the like is connected.

The sheet feed part 3, in which a plurality of paper sheets (recording medium) S are contained, separates and feeds out sheets S one by one in recording process. The sheet conveyance part 4 conveys a sheet S, which has been fed out from the sheet feed part 3, to the recording part 5 and the drying part 6, and moreover discharges the sheet S, which has been subjected to recording and drying, to a sheet discharge part 22. In a case where double-sided recording is executed, the sheet conveyance part 4 assorts a sheet S, whose first surface has been subjected to recording and drying, to a reversal conveyance part 43 and, with a conveyance direction switched over, further conveys the top/bottom reversed sheet S once again to the recording part 5 and the drying part 6.

The sheet conveyance part 4 includes a first belt conveyance part 41 and a second belt conveyance part 42. The first belt conveyance part 41 and the second belt conveyance part 42 each convey a sheet S on an upper-side outer surface (top surface) of their endless-shaped first conveyor belt 411 and second conveyor belt 421, respectively, while maintaining the sheet S in a sucked-and-held state. The first belt conveyance part 41 is placed below the recording part 5 to convey the sheet S. The second belt conveyance part 42 is positioned downstream of the first belt conveyance part 41 in a sheet conveyance direction, and placed at the drying part 6 to convey the sheet S.

The recording part 5 is placed, with a specified clearance, above the first conveyor belt 411 so as to face a sheet S conveyed in a sucked-and-held state on the upper surface of the first conveyor belt 411. The recording part 5, as shown in FIG. 2, holds head units 51B, 51C, 51M, 51Y corresponding to four colors of black, cyan, magenta and yellow, respectively. The head units 51B, 51C, 51M, 51Y are juxtaposed in succession along a sheet conveyance direction Dc so that their longitudinal directions become parallel to a sheet widthwise direction Dw perpendicular to the sheet conveyance direction Dc. In addition, since the four head units 51B, 51C, 51M, 51Y are identical in basic configuration thereamong, identification signs ‘B’, ‘C’, ‘M’, ‘Y’ representing individual colors may be omitted hereinafter except that those signs are needed for particular restriction.

Each head unit 51 for each individual color has line-type inkjet recording heads 52. In each individual-color head unit 51, a plurality (e.g., three (52a, 52b, 52c)) of recording heads 52 are arranged in a staggered shape along the sheet widthwise direction Dw.

Each recording head 52 has a plurality of ink ejection nozzles 521 at its bottom portion. The plurality of ink ejection nozzles 521 are placed in arrays along the sheet widthwise direction Dw, and enabled to eject ink over a whole recording region on the sheet S. That is, the recording head 52 has a plurality of ink ejection nozzles 521 for ejecting ink onto the sheet S. In the recording part 5, ink is ejected from the recording heads 52 of the four-color head units 51B, 51C, 51M, 51Y, respectively and sequentially, toward the sheet S being conveyed by the first conveyor belt 411, by which a full-color image or a monochrome image is recorded on the sheet S.

The drying part 6 is placed downstream of the recording part 5 in the sheet conveyance direction, and equipped with the second belt conveyance part 42. The sheet S, on which an ink image has been recorded in the recording part 5, has ink dried thereon while being conveyed as it is sucked and held on the second conveyor belt 421 in the drying part 6.

The controller 7 includes a CPU and a storage part as well as other electronic circuits and electronic components (none shown). Based on control programs and data stored in the storage part, the CPU controls operations of individual component elements provided in the inkjet recording apparatus 1 to execute processing related to functions of the inkjet recording apparatus 1. The sheet feed part 3, the sheet conveyance part 4, the recording part 5 and the drying part 6, upon receiving instructions individually from the controller 7, execute recording onto the sheet S in linkage with one another. The storage part consists of, for example, a combination of nonvolatile storage, such as program ROM (Read Only Memory) and data ROM, and volatile storage, such as RAM (Random Access Memory).

In addition, the controller 7 is enabled to execute a flashing (idle ejection) operation, which involves ink ejection from the recording heads 52, at a timing different from an ink ejection timing onto the sheet S (under an image recording situation), i.e., under a non-image recording situation, which involves no ink ejection onto the sheet S. Executing the flashing operation makes it possible to reduce and prevent clogging of the ink ejection nozzles 521 due to ink drying.

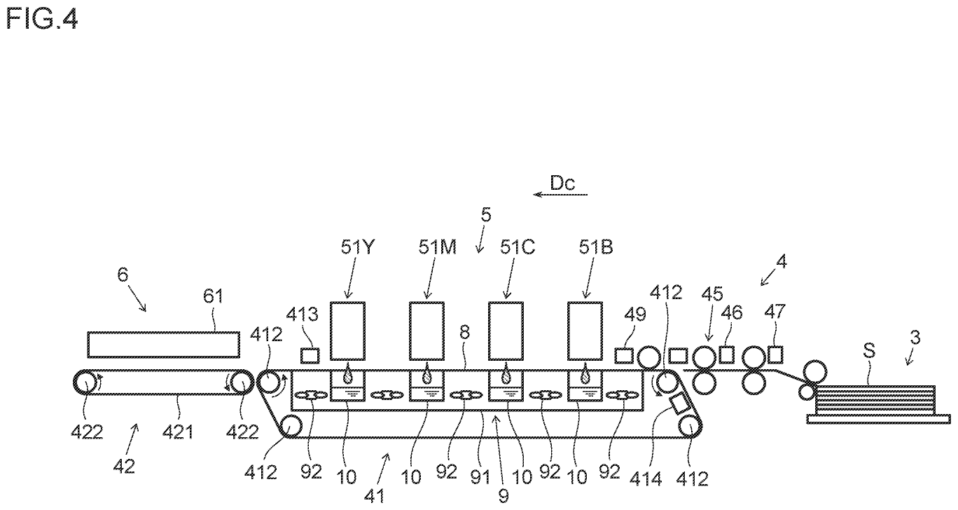

FIG. 4 is an explanatory view schematically showing a configuration extending from the sheet feed part 3 to the second belt conveyance part 42 along the sheet conveyance path in FIG. 1. Although ink (of drop shape) ejected from the recording heads 52 is depicted under the recording heads 52 in FIG. 4 for explanation's sake, actually ejected ink is far smaller in form than ink (of drop shape) depicted in FIG. 4.

As shown in FIG. 4, the sheet conveyance part 4 further includes a registration roller pair 45, a registration sensor 46, an abnormality detection part 47, and a sheet sensor 49.

The registration roller pair 45 is placed downstream of the sheet feed part 3 in the sheet conveyance direction Dc. Placed in downstream-side close vicinity to the registration roller pair 45 in the sheet conveyance direction De are the recording part 5 and the first belt conveyance part 41. A sheet S fed out from the sheet feed part 3 passes through the sheet conveyance part 4, arriving at a site of the registration roller pair 45. The controller 7 corrects any skewed feed of the sheet S by the registration roller pair 45, and after measuring a timing relative to the ink ejecting operation of the recording part 5, feeds out the sheet S toward the first belt conveyance part 41.

The registration sensor 46 is placed in upstream-side close vicinity to the registration roller pair 45 in the sheet conveyance direction Dc. The registration sensor 46 detects a sheet S which has been fed out from the sheet feed part 3 and arrives at the site of the registration roller pair 45. Based on a sheet S detection signal received from the registration sensor 46, the controller 7 controls rotation of the registration roller pair 45.

The abnormality detection part 47 is placed upstream of the registration sensor 46 in the sheet conveyance direction Dc. The abnormality detection part 47 includes a sensor for detecting an abnormality of the sheet S delivered from the sheet feed part 3 to the first belt conveyance part 41. That is, the abnormality detection part 47 detects an abnormality of the sheet S conveyed toward the recording heads 52. In more detail, the abnormality detection part 47 detects an abnormality of the sheet S conveyed under the recording heads 52. For instance, with regard to a sheet S fed out from the sheet feed part 3, the abnormality detection part 47 detects an abnormality related to a bend of the sheet S.

The sheet sensor 49 is placed downstream of the registration roller pair 45 in the sheet conveyance direction Dc and upstream of the recording part 5 in the sheet conveyance direction De as well as above the first belt conveyance part 41. The sheet sensor 49 is a sensor for detecting a conveyance-directional position of the sheet S conveyed by the first belt conveyance part 41. Based on a sheet S detection signal received from the sheet sensor 49, the controller 7 controls the ink ejecting operation from the ink ejection nozzles 521 for the sheet S that has been conveyed up to a position facing each of the individual-color recording heads 52 by the first belt conveyance part 41.

The first belt conveyance part 41 is placed so as to face a lower surface of the recording part 5. The first belt conveyance part 41, while maintaining the sheet S sucked and held on its upper surface, conveys the sheet S along the sheet conveyance direction Dc to positions corresponding to the recording heads 52, i.e., under the recording heads 52. The first belt conveyance part 41 includes a first conveyor belt 8, rollers 412, and a first belt sensor 413, and a second belt sensor 414.

The first conveyor belt 8 is an endless belt which is stretched over four rollers 412 placed inside. The rollers 412 are placed inside the first conveyor belt 8, and supported so as to be rotatable about a rotational axis line extending along the sheet widthwise direction Dw (see FIG. 2). One of the four rollers 412 is a driving roller, and the first conveyor belt 8 is rotated by the driving roller such that its upper side is moved in the sheet conveyance direction Dc. The first conveyor belt 8 has a plurality of pores 81 and a plurality of openings 82 (opening groups 83) both extending through over a top-to-bottom range (see FIG. 5). The first conveyor belt 8 conveys the sheet S to positions facing lower surfaces of the recording heads 52.

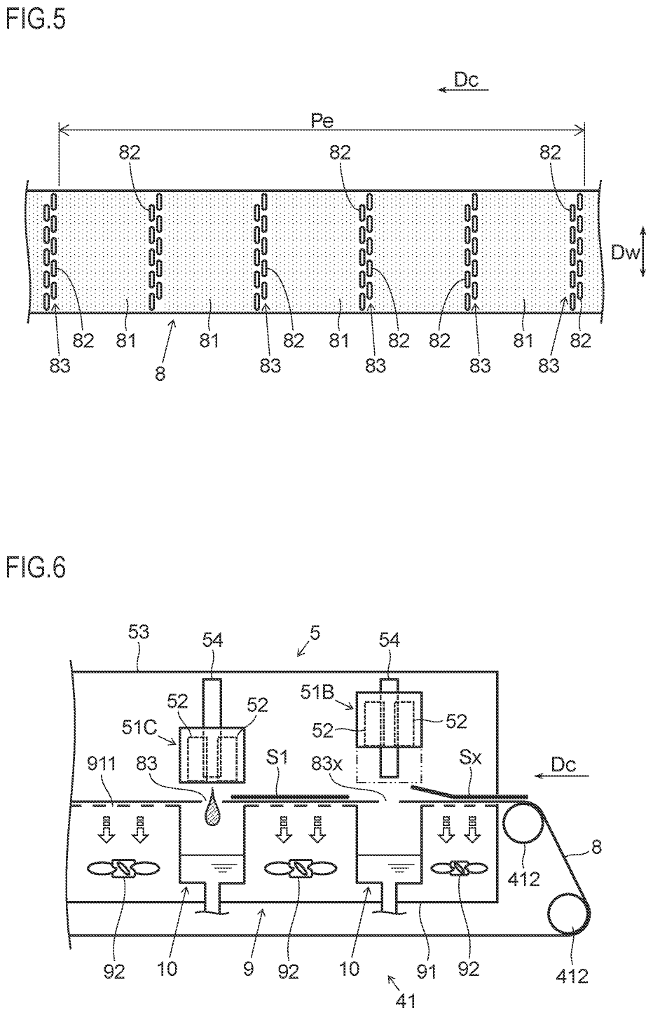

The first belt sensor 413 is placed downstream of the recording part 5 in the sheet conveyance direction Dc and above the first belt conveyance part 41. The second belt sensor 414 is placed inside the first conveyor belt 8 and upstream of one roller 412 in the rotational direction of the first conveyor belt 8, where the one roller 412 is adjacent to an upstream end portion of the upper side of the first conveyor belt 8 in the sheet conveyance direction Dc. Each of the first belt sensor 413 and the second belt sensor 414 detects a position of an opening group 83 (see FIG. 6) which is a set of plural openings 82 provided in the first conveyor belt 8. In addition, the first belt sensor 413 is equivalent in function to the sheet sensor 49.

The second belt conveyance part 42 is placed in the drying part 6. The second belt conveyance part 42 conveys the sheet S along the sheet conveyance direction De while maintaining the sheet S in a sucked-and-held state on its upper surface. The second belt conveyance part 42 includes the second conveyor belt 421 and rollers 422.

The second conveyor belt 421 is an endless belt, which is stretched over two rollers 422 placed inside. The rollers 422 placed inside the second conveyor belt 421 are supported so as to be rotatable about a rotational axis line extending along the sheet widthwise direction Dw (see FIG. 2). One of the two rollers 422 is a driving roller, by which the second conveyor belt 421 is rotated such that its upper side is moved in the sheet conveyance direction Dc.

The drying part 6 includes a dryer 61. The sheet S on which an image has been recorded by the recording part 5 is dried by the dryer 61 in the drying part 6 during conveyance by the second belt conveyance part 42. The sheet S having been dried by the dryer 61 is conveyed downstream of the drying part 6 in the sheet conveyance direction Dc.

As shown in FIG. 4, the inkjet recording apparatus 1 further includes a sheet suction part 9 and ink receiving parts 10.

The sheet suction part 9, which is located in upper portion inside the first conveyor belt 8, is placed so as to face one surface (upper-side inner surface, back surface) of the first conveyor belt 8 opposed to its sheet conveyance surface (upper-side outer surface, top surface). The sheet suction part 9 includes a sheet suction casing 91 and air intake fans 92.

The sheet suction casing 91 internally has a suction space surrounded in four directions by side walls. In regions where the first conveyor belt 8 and the recording heads 52 do not face each other on upstream side and downstream side of regions in the sheet conveyance direction Dc where the first conveyor belt 8 and the recording heads 52 face each other, the suction space faces one surface (upper-side inner surface, back surface) of the first conveyor belt 8 opposed to its sheet conveyance surface (upper-side outer surface, top surface). The suction space faces one surface of the first conveyor belt 8 opposed to its sheet conveyance surface in mostly five regions within a range from upstream-side underside of the black recording head 52B in the sheet conveyance direction Dc to downstream-side underside of the yellow recording head 52Y in the sheet conveyance direction Dc.

The sheet suction casing 91 has a plurality of suction pores 911 placed in upper portion of the suction space and in an upper surface of the sheet suction casing 91 facing the first conveyor belt 8 (see FIG. 6). The plurality of suction pores 911 extend vertically through the sheet suction casing 91.

The air intake fans 92 are placed in lower portion of the suction space inside the sheet suction casing 91. In addition, as shown in FIG. 5, the first conveyor belt 8 has a plurality of pores 81 and a plurality of openings 82. FIG. 5 is a plan view of the first conveyor belt 8 of the first belt conveyance part 41 of FIG. 4.

The pores 81 and the openings 82 extend through over a top-to-bottom range of the first conveyor belt 8. When the air intake fans 92 are driven, the sheet suction part 9 sucks air through the suction pores 911 of the sheet suction casing 91 as well as through the pores 81 and openings 82 of the first conveyor belt 8 so that the sheet S is sucked up to the sheet conveyance surface (upper-side outer surface, top surface) of the first conveyor belt 8.

With air sucked by the sheet suction part 9, the plurality of pores 81 and the plurality of openings 82 allow the sheet S to be sucked up to the upper-side outer surface (top surface), i.e. sheet conveyance surface, of the first conveyor belt 8. Opening area of each opening 82 is larger than opening area of each pore 81. The openings 82 allow ink ejected from the recording heads 52 to pass therethrough in flashing operation. The openings 82 aggregate on a plurality (e.g., ten) basis to make up opening groups 83.

The first conveyor belt 8, as shown in FIG. 5, has a plurality of opening groups 83, e.g. five opening groups 83 in this embodiment, in one period Pe of the sheet conveyance direction Dc. The opening groups 83 are placed, e.g. equidistantly from one another, in one period Pe of the first conveyor belt 8 in the sheet conveyance direction Dc. In flashing operation, ink ejected from all the ink ejection nozzles 521 of the recording heads 52 passes through any ones of the openings 82 of the opening groups 83. The pores 81 are placed between neighboring opening groups 83 in the sheet conveyance direction Dc. No pores 81 are placed in regions in which the opening groups 83 are provided.

The ink receiving parts 10 are placed under and opposite the recording heads 52 with the first conveyor belt 8 therebetween. The suction space of the sheet suction casing 91 adjoins each ink receiving part 10 on its upstream side and downstream side of the sheet conveyance direction Dc. In flashing operation, the ink receiving parts 10 receive ink that has passed through the openings 82 of the first conveyor belt 8.

In addition, although not shown, the inkjet recording apparatus 1 further includes liquid suction parts. The liquid suction parts are placed under the ink receiving parts 10 and connected to the ink receiving parts 10, respectively. The liquid suction parts suck up and discharge ink or other liquid stored in the ink receiving parts 10.

FIG. 6 is a schematic partial cross-sectional front view of around the recording part 5 of FIG. 4. FIG. 6 shows that a first sheet SI on the upstream side of the first conveyor belt 8 in the sheet conveyance direction De is of normalcy, while a second sheet Sx is of such abnormality that its fore end is upwardly bent.

As shown in FIG. 6, the recording part 5 further includes wall portions 53 and retraction mechanisms 54.

The wall portions 53 are placed on front side and back side, respectively, of the first conveyor belt 8, with the first conveyor belt 8 therebetween, in opposition to the sheet widthwise direction Dw, extending in the sheet conveyance direction Dc and an up/down direction. Each individual-color head unit 51 is placed between front-side and back-side wall portions 53 in the sheet widthwise direction Dw and supported by those wall portions 53, respectively.

The retraction mechanisms 54 are provided for the front-side and back-side wall portions 53, respectively. The individual-color head units 51 are supported via the retraction mechanisms 54 by the wall portions 53, respectively. Each retraction mechanism 54 makes the head unit 51 moved between a recording position for execution of recording on the sheet S and a retraction position that is more distant from the first belt conveyance part 41 than the recording position. The retraction mechanism 54 includes a driving source, a slide guide member, a gear mechanism, a wire mechanism, a link mechanism and the like (none shown) with a purpose of moving the head unit 51. In this embodiment, the retraction mechanism 54 moves up the recording head 52 from the recording position to the retraction position to fulfill retraction.

In addition, the retraction mechanisms 54 are enabled to move up and down the four-color head units 51B, 51C, 51M, 51Y individually, and move up and down a plurality out of those head units simultaneously, and moreover move up and down the four head units simultaneously. More specifically, for up-and-down movement of the head units 51 along with the conveyance of the sheet S as an example, the retraction mechanisms 54 are enabled to sequentially move up the head units 51, starting with the most-upstream-placed head unit 51B in the sheet conveyance direction De and subsequently treating the rest of the head units 51 in order along the sheet conveyance direction Dc, and thereafter to move down the head units 51, starting with the head unit 51B and subsequently the rest of the head units in order along the sheet conveyance direction Dc.

Then, in a case where an abnormality of the sheet S has been detected by the abnormality detection part 47, the controller 7 of the inkjet recording apparatus 1 in this embodiment halts a flashing operation set for a forward proximity of the abnormality-detected sheet S, and instructs the retraction mechanism 54 to move up the recording head 52 to the retraction position, allowing the abnormality-detected sheet S to pass through under the recording head 52.

For instance, as shown by the first sheet SI on the upstream side of the first conveyor belt 8 in the sheet conveyance direction De in FIG. 6, in a case where no abnormality has been detected with the sheet S by the abnormality detection part 47, the controller 7 executes the flashing operation, which has been set for an opening group 83 immediately forward of each sheet S, at a specified timing, and further executes image recording onto the sheet S.

Meanwhile, as shown by the second sheet Sx on the upstream side of the first conveyor belt 8 in the sheet conveyance direction De in FIG. 6, in a case where an abnormality has been detected with the second sheet Sx by the abnormality detection part 47, the controller 7 halts a flashing operation set for an opening group 83x immediately forward of the abnormality-detected sheet Sx. Then, the controller 7 instructs the retraction mechanism 54 to move up the head unit 51 including the recording head 52 to the retraction position, allowing the abnormality-detected sheet Sx to pass through under the recording head 52.

According to the above-described configuration, when an abnormality has arisen with a sheet Sx and the recording head 52 is moved up to the retraction position so that the sheet Sx is allowed to pass through under the recording head 52, a flashing operation set for an opening group 83x immediately forward of the abnormality-detected sheet Sx is halted. As a result, contaminations due to ink diffusion within the apparatus can be suppressed in flashing operation.

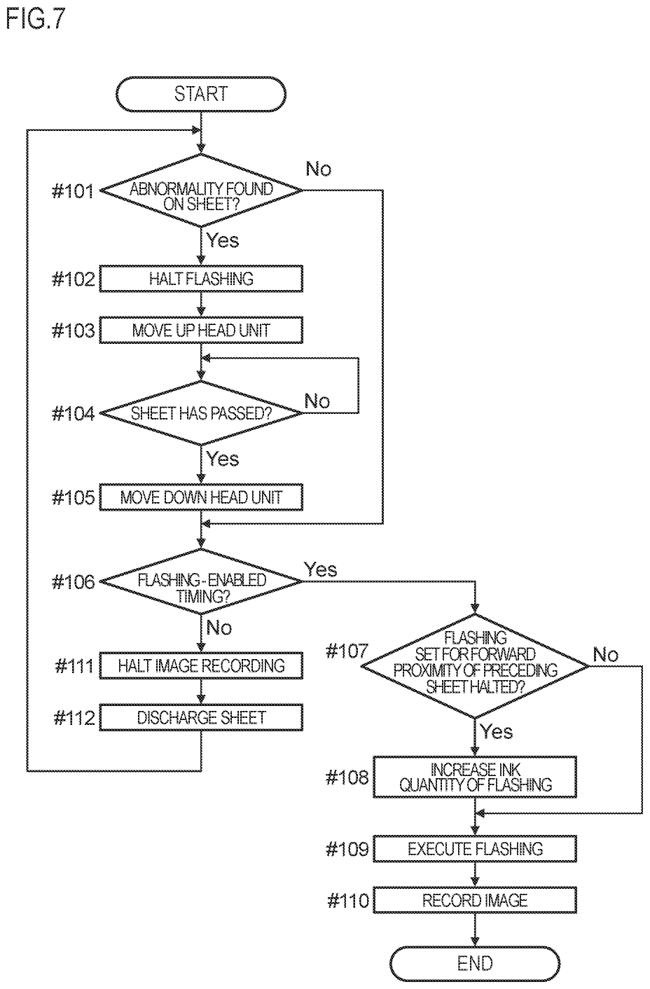

Next, an example of the flashing operation will be described along its flow. FIG. 7 is a flowchart showing an example of execution process of a flashing operation in the inkjet recording apparatus of FIG. 1.

When conveyance of a sheet S gets started in the inkjet recording apparatus 1 (START in FIG. 7), the controller 7 decides whether or not any abnormality exists with the sheet S conveyed under the recording heads 52 (step #101). An abnormality of the sheet S conveyed under the recording heads 52 is detected by the abnormality detection part 47, and its detection signal is transmitted to the controller 7.

On condition that an abnormality has been detected with the sheet S conveyed under the recording heads 52 (YES at step #101), the controller 7 halts a flashing operation set for a forward proximity of the abnormality-detected sheet S (step #102). Meanwhile, on condition that no abnormality has been detected with the sheet S conveyed under the recording heads 52 so that the sheet S is of normalcy (NO at step #101), the processing flow moves on to step #106.

Next, the controller 7 instructs a retraction mechanism 54 to move up a head unit 51 including the recording head 52 to the retraction position (step #103). Subsequently, the controller 7 decides whether or not the abnormality-detected sheet S has passed through under the recording head 52 (step #104), followed by a standby state until the sheet S has passed through (NO at step #104).

In addition, the recording head 52 does not need to be positioned at its movable highest point at a time point when the abnormality-detected sheet S passes through under the recording head 52. The recording head 52 needs only to be moved up from the recording position to such an extent that the abnormality-detected sheet S is allowed to pass through under the recording head 52.

When the abnormality-detected sheet S has passed through under the recording head 52 (YES at step #104), the controller 7 instructs the retraction mechanism 54 to move down the head unit 51 including the recording head 52 to the recording position (step #105). In addition, the abnormality-detected sheet S is discharged to the sheet discharge part 22 or the like.

Next, the controller 7 resumes the flashing operation that has been halted at step #102. More specifically, after the abnormality-detected sheet S has passed through under the recording head 52, the controller 7 instructs the retraction mechanism 54 to move down the recording head 52 to the recording position to thereby make a restoration, resuming the flashing operation. With this configuration, the flashing operation can be carried out before image recording for subsequent sheets S. As a result, suitable ink ejection performance can be maintained, making it possible to continue high-quality image recording.

Then, the controller 7 decides whether or not it is a flashing operation-enabled timing (step #106). In more detail, it is decided whether or not a sheet S subsequent to the abnormality-detected sheet S has arrived at under the recording head 52. When the subsequent sheet S has arrived at under the recording head 52, the flashing operation is inexecutable.

On condition that the flashing operation is executable (YES at step #106), the controller 7 decides whether or not a flashing operation set for a forward proximity of the preceding sheet S has been halted (step #107).

On condition that the flashing operation set for a forward proximity of the preceding sheet S has been halted (YES at step #107), the controller 7 increases ink quantity for the next flashing (step #108). More specifically, after resumption of the flashing operation, the controller 7 increases ink quantity to be ejected from the recording heads 52 in flashing. Although halting the preceding flashing operation may worsen thickening of ink within the ink ejection nozzles 521, yet the above-described configuration makes it possible to solve the worsened thickening of ink. As a result, ink ejection performance can be restored, making it possible to continue high-quality image recording.

Furthermore, the controller 7 may eject, from the recording heads 52, an increment of ink quantity in divided plural times of flashing. Whereas increasing the ink quantity in flashing may cause ink to be deposited at edge portions of the openings 82 of the first conveyor belt 8, adopting the configuration of this disclosure makes it possible to suppress ink deposition onto the first conveyor belt 8 in flashing. As a consequence, it becomes possible to suppress ink contaminations on the sheet S being conveyed on the first conveyor belt 8.

Also, on condition that the flashing operation set for a forward proximity of the preceding sheet S has not been halted (NO at step #107), the processing flow moves on to step #109 without any increase in ink quantity for next flashing.

Next, the controller 7 executes the flashing operation (step #109). Subsequently, the controller 7 records an image on a sheet S conveyed immediately after the execution of the flashing operation (step #110). Then, the flow related to the flashing operation is ended (END in FIG. 7).

Meanwhile, on condition that it is not a flashing operation-enabled timing at step #106 (NO at step #106), more specifically, that a sheet S subsequent to the abnormality-detected sheet S has arrived at under the recording head 52, the controller 7 halts image recording on the subsequent sheet S (step #111).

In other words, on condition that the subsequent sheet S has arrived at under the recording head 52 before resumption of the flashing operation, the controller 7 halts the image recording on the sheet S. With this configuration, a process of executing image recording on the sheet S after execution of the flashing can be maintained. As a result, suitable ink ejection performance can be maintained, making it possible to continue high-quality image recording.

Next, the controller 7 discharges the sheet S, for which image recording has been halted, to the sheet discharge part 22 or the like (step #112). Then, the flow related to the flashing operation returns to step #101.

On condition that an abnormality has been detected with the sheet S conveyed under a recording head 52 (YES at step #101), countermeasures may be as follows.

First, at a detection timing when an abnormality has been detected, the controller 7 may halt image recording and make the recording head 52 moved up to the retraction position. Such control is preferable to protect the recording head 52 from the abnormality-detected sheet S.

Also, the controller 7 may derive a retraction start timing as the latest timing from among timings at which the recording head 52 starts to move up toward the retraction position, the timings causing the abnormality-detected sheet S to pass through under the recording head 52 after the recording head 52 has completely moved up to the retraction position.

Then, on condition that a timing of recording completion for the sheet S on which image recording is underway at its detection timing is later than the retraction start timing, the controller 7 halts the image recording for the under-recording sheet S. That is, on condition that there is a sheet S on which image recording is underway at a time when the recording head 52 starts to move up toward the retraction position, the controller 7 halts the image recording on the sheet S. Then, the controller 7 makes the recording head 52 moved up at or before the retraction start timing.

Before making the recording head 52 moved up, the controller 7 may execute a flashing operation, which is other than image recording, on the halfway-on-recording sheet S. As a result, suitable ink ejection performance can be maintained, making it possible to continue high-quality image recording. Since the flashing operation is executed for a halfway-on-recording sheet S, no excess sheets S are consumed. It is noted that a halfway-on-recording sheet S is discharged to the sheet discharge part 22 or the like.

The above-described flashing operation being a special case, ink is ejected not toward the openings 82 of the first conveyor belt 8 but toward the sheet S. The flashing operation in this case, as in a normal flashing operation, may involve ink ejection suited to an arrangement of the openings 82 of the first conveyor belt 8. As a result of this, it becomes easier to control the flashing operation. Further, the flashing operation in this case may involve ink ejection simply onto one straight line or onto a plurality of straight lines. As a result of this, the flashing operation can be finished in shorter time.

On condition that the retraction start timing is later than a timing of recording completion on a sheet S being under image recording at a detection timing, countermeasures may further be as follows.

The controller 7 checks up to which one sheet S out of subsequent sheets S being conveyed to the recording part 5 can be completed in terms of image recording before the retraction start timing. The controller 7 determines sheets S actually subjected to image recording out of the sheets S that can be completed for recording, and after execution of image recording for up to the determined sheets S, halts the image recording for following sheets S, moving up the recording head 52 to the retraction position.

On condition that only one sheet-to-sheet interval exists between sheets S passing under the recording heads 52 during a period from the detection timing until the retraction start timing, the recording is halted at a point in the one interval. On condition that a plurality of sheet-to-sheet intervals exist, which one interval the recording is halted at can be determined from viewpoints of head protection and ejection-performance retention. For example, halting the recording at the sheet-to-sheet interval nearest to the detection timing makes it possible to give priority to the protection of the recording heads 52. Also, halting the recording at the sheet-to-sheet interval nearest to the retraction start timing makes it possible to maintain suitable ink ejection performance and therefore continue high-quality image recording. What is more, enhanced productivity can be obtained.

No matter up to which one sheet S is subjected to execution of image recording, in a case where any sheet-to-sheet interval between sheets passing through under the recording heads 52 exists during a period from detection timing until retraction start timing, halting the image recording at the sheet-to-sheet interval makes it possible to suppress halfway-ended image recording on sheets S. Also, no matter up to which sheet S image recording is executed on, absolutely no image recording is executed for a sheet S positioned under the recording head 52 at a time when the recording head 52 starts to move up toward the retraction position.

Furthermore, on condition that a flashing operation-enabled sheet-to-sheet interval exists during a period from detection timing until retraction start timing, the recording head 52 may be moved up after execution of the flashing operation.

As described above, the controller 7 predicts whether or not the flashing operation is enabled during a period from detection timing until retraction start timing, and based on a prediction result, executes or halts the flashing operation during the period.

Although an embodiment of this disclosure has been fully described hereinabove, yet the disclosure is not limited to the scope of this description and may be modified in various ways unless those modifications depart from the gist of the disclosure.

What is claimed is:

1. An inkjet recording apparatus comprising:
a recording head for ejecting ink onto a recording medium to record an image thereon;
a recording medium conveyance part which is placed in opposition to the recording head and which conveys the recording medium;
an abnormality detection part for detecting an abnormality of the recording medium conveyed toward the recording head;
a retraction mechanism for moving the recording head between a recording position for execution of recording and a retraction position; and
a controller for controlling operations of the recording head, the recording medium conveyance part, and the retraction mechanism, wherein
the controller being enabled to execute a flashing operation, which involves ejection of ink from the recording head, under a non-image recording situation in which no ink is ejected onto the recording medium, on condition that an abnormality of the recording medium has been detected by the abnormality detection part, the controller halts the flashing operation set for a forward proximity of the abnormality-detected recording medium, and moreover instructs the retraction mechanism to move the recording head to the retraction position so as to allow the abnormality-detected recording medium to pass through a position of the recording head.

2. The inkjet recording apparatus according to claim 1, wherein
after the abnormality-detected recording medium has passed through the position of the recording head, the controller instructs the retraction mechanism to move the recording head to the recording position, and resumes the flashing operation.

3. The inkjet recording apparatus according to claim 2, wherein
on condition that a subsequent aforementioned recording medium has arrived at the position of the recording head before resumption of the flashing operation, the controller halts image recording onto the recording medium.

4. The inkjet recording apparatus according to claim 2, wherein
after resumption of the flashing operation, the controller increases ink quantity to be ejected from the recording head in the flashing.

5. The inkjet recording apparatus according to claim 4, wherein
the controller makes an increment of the ink quantity ejected, from the recording head, in divided plural times of aforementioned flashing.

6. The inkjet recording apparatus according to claim 1, wherein
after the recording head has been moved to the retraction position, the controller derives a retraction start timing for starting movement of the recording head to the retraction position so as to allow the abnormality-detected recording medium to pass through the position of the recording head, and predicts whether or not the flashing operation is executable during a period from a detection timing of the abnormality detection of the recording medium until the retraction start timing, and based on a prediction result, executes or halts the flashing operation during the period.

7. The inkjet recording apparatus according to claim 1, wherein
the controller executes absolutely no image recording for the recording medium located in the position of the recording head at a time when the recording head starts to move to the retraction position.

8. The inkjet recording apparatus according to claim 1, wherein
on condition that there is an aforementioned recording medium that is underway of image recording at a time when the recording head starts to move to the retraction position, the controller halts image recording onto the recording medium, and executes the flashing operation, which is other than image recording, for the halfway-on-recording recording medium.
